(19) United States
(12) Patent Application Publication
(10) Pub. No.: US 2007/0238451 A1
(43) Pub. Date: Oct. 11, 2007

(54) Apparatus, method, computer program product and a data structure providing a contact list enhanced with a special contact indication for use in automatically generating a call back

(75) Inventor: Mihaly Borzsei, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/400,326

(22) Filed: Apr. 6, 2006

(51) Int. Cl. H04M 3/00

(52) U.S. Cl. 455/418

(57) ABSTRACT

A method includes, in response to receiving an incoming call at a telephone, indicating acceptance of the call; determining with the telephone if the incoming call is from a party designated as a special contact; if it is, automatically rejecting the incoming call and automatically initiating a call back to the party.

### TECHNICAL FIELD

The teachings in accordance with the exemplary embodiments of this invention relate generally to communication devices and methods and, more specifically, relate to communication device contact list applications, such as a wireless communication device contact list applications.

### BACKGROUND

In certain telephones and telephone-like systems, such as in handheld wireless communication devices, it is possible to store a list of telephone numbers in association with other information, such as a name of a person or an organization associated with each stored telephone number (e.g., a contact list). By then scrolling through the list the user is enabled to select one number to be automatically dialed by the communication device to initiate a voice or a data call. If available, the call can be initiated via a voice user interface.

A traditional approach to phone use, including wireless mobile phone use, treats each mobile phone owner as a financially equal independent personality. The party who initiates a mobile call or sends a message is expected to pay the bill. However, people tend to create social networks such the family, school mates or hobby clubs. These alliances are typically centrally managed and each member shares the cost. It is also common that the strongest member, in case of the family typically the parents, have the primary financial responsibility and pay the bills. Other family members, such as children without income, may use a variety of the services. The shift in the balance more frequently occurs when parties to a call live in different countries having different living standards. In this case the party living in the country with the higher living standard may be assumed to be the (financially) stronger party.

Mobile conversation participants may be close friends, but they may not be in financially equal positions. In this case the financially stronger participant may have an interest to pay for the conversation, even if the conversation or message is initiated by financially weaker participant. However, at present there is no easy to use and cost effective user interface element to indicate that a call is accepted, and that the called party is willing to pay for the call instead of the call initiator.

For example, at present this situation might be handled using a number of manually executed steps, such as rejecting the call, opening a call log and calling the rejected number listed in the call log.

For the case of an incoming message there is no equivalent procedure. A traditional call back process in mobile environment involves a standard “call me back” message. However, in this case and on those mobile phone interfaces that support such as a notification, the entire message content is not displayed, and furthermore the process would require several manual operations to accomplish the call back. These operations may include removing a key lock or opening the cover, and then several subsequent user operations need to be performed until the message sender is called back, especially when there is more than one mobile phone number involved.

In fixed phone line service a so-called green number may be used, which is designed for customer care of, for example, a national or local service provider (e.g., electricity or water supply). Reference can be made, for example, to a service provided by PanTel of Budapest, Hungary (http://www.pantel.hu/index.php?id=50&L=1). In this system the number can be called at no charge, and the called party pays for the call. The accessibility is granted for fixed lines, but access from home mobile networks depends on the individual operator and its agreements with other operators. Service access from an international mobile is not discussed.

When the stronger party lives abroad, forwarding a call to that mobile number would include roaming and therefore can be more expensive than the same call as an international call from abroad, through a low cost international call provider.

Other approaches may involve an SMS gateway and short messaging to signal call-backs, as well as web based solutions. Most of these solutions require centralized call back handling, and some assume that the call back should take place within a short time after the first call take place. This is true for the call back centers, but may not be true when a mobile phone user is not expecting the call. Traditional call back typically requires special hardware and a subscription to a call back service, which makes it difficult to use.

It is also known to add individual items to phone contacts, such as photos, ringing tones, or presence. Presence-enhanced contacts can aid in avoiding calling people when they are not able to accept calls, but they are not designed for personal messaging, nor for initiating a call back session.

### SUMMARY OF THE EXEMPLARY EMBODIMENTS

The foregoing and other problems are overcome, and other advantages are realized, in accordance with the non-limiting and exemplary embodiments of this invention.

In accordance with the exemplary embodiments of this invention there is provided a method that includes, in response to receiving an incoming call at a telephone, indicating acceptance of the call; determining with the telephone if the incoming call is from a party designated as a special contact; if it is, automatically rejecting the incoming call and automatically initiating a call back to the party.

Further in accordance with the exemplary embodiments of this invention there is provided a computer program product that is embodied in at least one computer readable storage media and that comprises program instructions the execution of which by at least one data processor results in operating a telephone by operations that comprise, in response to receiving an incoming call, and in response to an indication of acceptance of the call; determining if the incoming call is from a party designated as a special contact; if it is, automatically rejecting the incoming call; and automatically initiating a call back to the party.

Still further in accordance with the exemplary embodiments of this invention there is provided a device that comprises an interface to a communications network; at least one data processor; at least one memory coupled to the at least one data processor, the at least one memory storing a contact list; and a user interface coupled to the at least one data processor. The data processor is responsive to receiving an incoming call via the network interface, and to an indication of acceptance of the call, to determine if the incoming call is from a party designated as a special contact in the contact list and, if it is, to automatically reject the incoming call and to automatically initiate a call back to the party.

The exemplary embodiments of this invention also encompass a data structure stored in a memory that is accessible by a wireless terminal. The data structure comprises a contact list having at least one entry comprising a field for storing data indicative of at least one telephone number, a field for storing data indicative of an identification of a party associated with the at least one telephone number, and a field for storing data indicative of whether the party is a special contact who, if a call is received from the special contact, the call is terminated automatically and a call back is performed automatically to the at least one telephone number.

The exemplary embodiments of this invention further encompass an apparatus that comprises means for receiving an incoming call; means, responsive to an indication of call acceptance, for determining if the incoming call is from a party designated as a special contact in a stored contact list; and means, responsive to the determination being affirmative, for automatically rejecting the incoming call and for automatically initiating a call back to the party using call back information stored in the contact list.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram an embodiment of a wireless communications system having devices that are suitable for practicing the exemplary embodiments of this invention;

FIG. 2 is a logic flow diagram that is illustrative of a method in accordance with the invention.

FIGS. 3-5 depict in further detail the exemplary method shown in FIG. 2, where:

FIG. 3 is a logic flow diagram that is illustrative of a method in accordance with the exemplary embodiments of this invention for handling an incoming call from a party that results in a call back;

FIG. 4 is a logic flow diagram that is illustrative of a method in accordance with the exemplary embodiments of this invention for handling a message sent to the phone of a mobile user, and the pulling of the message with a data call; and

FIGS. 5A and 5B, collectively referred to as FIG. 5, show logic flow diagrams that are illustrative of a method in accordance with the exemplary embodiments of this invention for handling the case of a missed call that is displayed or added to a timed missed calls list.

FIG. 6 illustrates call logs and the call processing that occurs in the Block 3C of FIG. 3 for a case where both the calling party and the called party list the other as a special contact.

FIG. 7 shows a portion of a contact list entry, and is descriptive of a data structure that that stores a special contact indicator.

### DETAILED DESCRIPTION

By way of introduction, the exemplary embodiments of this invention provide an enhanced mobile phone contact list that includes an ability to indicate whether a calling party is one that should be automatically called back, at the expense of the originally called party. In accordance with the exemplary embodiments of this invention, the incoming call can be automatically rejected, and a call made automatically (or under user control) to the originally calling party.

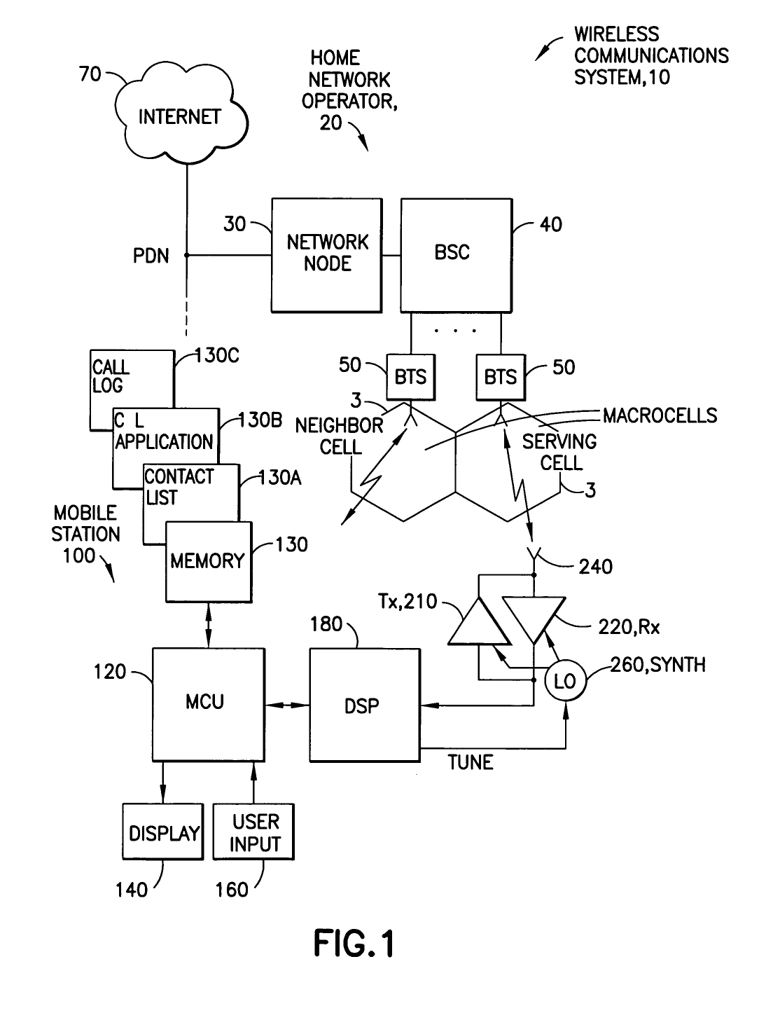

Before describing further the exemplary embodiments of this invention, reference will be made first to FIG. 1 for showing as a simplified block diagram an embodiment of a wireless communications system 10 that is suitable for practicing the exemplary embodiments of this invention. The wireless communications system 10 includes at least one wireless communications device, such as a cellular telephone, or a terminal, or more generally a mobile station (MS) 100. FIG. 1 also shows an exemplary network operator 20 having, for example, a node 30 for connecting to a telecommunications network, such as a Public Packet Data Network or PDN, at least one base station controller (BSC) 40 or equivalent apparatus, and a plurality of base transceiver stations (BTS) 50, also referred to as base stations (BSs), that transmit in a forward or downlink direction both physical and logical channels to the mobile station 100 in accordance with a predetermined air interface standard. A reverse or uplink communication path also exists from the mobile station 100 to the network operator, which conveys mobile originated access requests and traffic. In a cellular type of system a cell 3 is associated with each BTS 50, where one cell will at any given time be considered to be a serving cell, while an adjacent cell(s) will be considered to be a neighbor cell. Smaller cells (e.g., picocells) may also be available.

In some types of systems MS 100 may be referred to as User Equipment (UE), and BS may be referred to as a Node-B.

The air interface standard can conform to any suitable standard or protocol, such as CDMA, WCDMA, and TDMA-based systems such as GSM, WiFi, UWB and may enable both voice and data traffic, such as data traffic enabling Internet 70 access and web page downloads.

The mobile station 100 typically includes a control unit or control logic, such as a microcontrol unit (MCU) 120 having an output coupled to an input of a display 140 and an input coupled to an output of a keyboard or keypad 160. The mobile station 100 may be a handheld radiotelephone, such as a cellular telephone or a personal communicator. The mobile station 100 could also be contained within a card or module that is connected during use to another device. For example, the mobile station 10 could be contained within a PCMCIA or similar type of card or module that is installed during use within a portable data processor, such as a laptop or notebook computer.

In general, the various embodiments of the MS 100 can include, but are not limited to, cellular telephones, personal digital assistants (PDAs) and portable computers, and may include or incorporate, as non-limiting examples, image capture devices such as digital cameras, gaming devices, music storage and playback appliances, Internet appliances permitting Internet access and browsing, as well as units or terminals that incorporate combinations of such functions.

It should be noted that the exemplary embodiments of this invention are not limited for use with wireless portable communication terminals, and can be practiced as well with communication devices that are connected by a wire or a cable (wired devices) to a telephone operator system, including those types of communication devices that employ voice over Internet (VoIP) technology. In general, it is assumed that the device will include or be coupled to some type of display for displaying at least a contact list to a user, as well as some type of user input to enable the user to enter information, as will be described in further detail below.

Still referring to FIG. 1, the MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the MCU 120 to execute the software routines, layers and protocols required to implement the methods in accordance with this invention, as well as to provide a suitable user interface (UI) with a user via display 140 and a suitable user input 160. Although not shown, a microphone and speaker are typically provided for enabling the user to conduct voice calls in a conventional manner.

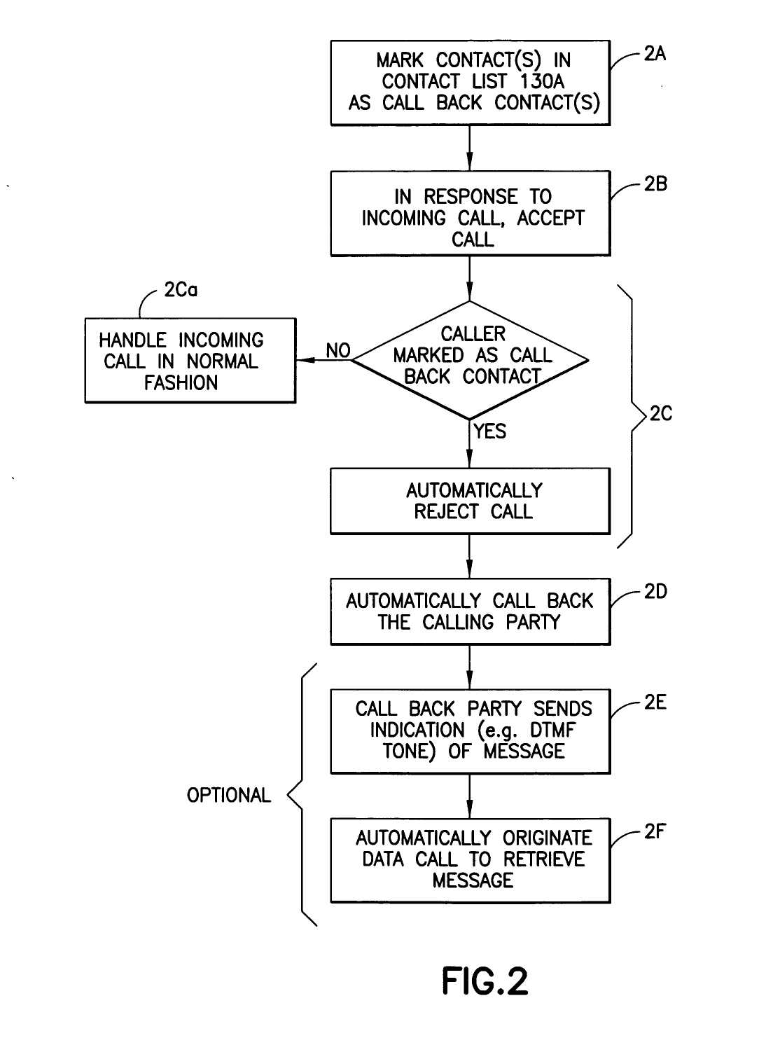

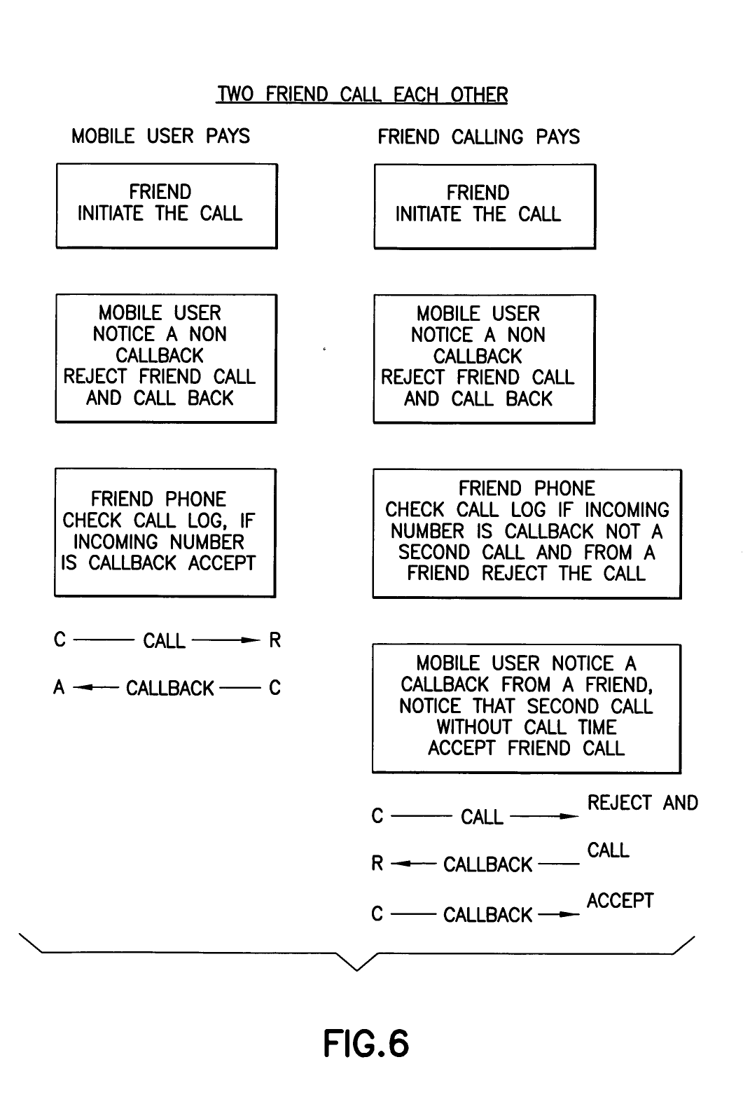

Stored in the memory 130 is assumed to be a contact list 130A that is established, managed and used in accordance with the exemplary embodiments of this invention so as to include an ability to mark one or more contact entries as “special contacts”, as described below in reference to FIGS. 2-7. Associated with the contact list 130A is a contact list (CL) application 130B that comprises computer executable program code that is suitable for use in implementing the exemplary embodiments of this invention, as described more fully below. A call log 130C may also be present, and may be used as discussed below in reference to FIG. 6.

The mobile station 100 contacts list memory 130A may be programmed locally using the available user interface, and/or it may be programmed via remote UI on a personal computer or another mobile station, for example in a case where MS 100 has only a voice UI interface, and no keys and/or displays. The air interface may be available separately, such as in the case of an internet tablet (e.g., Nokia 770™) that handles VoIP calls.

The mobile station 100 also contains a wireless section that includes a digital signal processor (DSP) 180, or equivalent high speed processor or logic, as well as a wireless transceiver that includes a transmitter 200 and a receiver 220, both of which are coupled to an antenna 240 for communication with the network operator. At least one local oscillator, such as a frequency synthesizer (SYNTH) 260, is provided for tuning the transceiver. Data, such as digitized voice and packet data, is transmitted and received through the antenna 240. The wireless section may be considered to function as an interface to a communications network, such as the operator network 20 and or the Internet 70.

The exemplary embodiments of this invention may be implemented by computer software (e.g., the CL application 103B) executable by a data processor of the mobile station 100, such as the processor 120, or by hardware, or by a combination of software and hardware. Further in this regard it should be noted that the various blocks of the logic flow diagram of, for example, FIG. 2 (described below) may represent program steps, or interconnected logic circuits, blocks and functions, or a combination of program steps and logic circuits, blocks and functions.

The memory 130 may be of any type suitable to the local technical environment and may be implemented using any suitable data storage technology, such as semiconductor-based memory devices, magnetic memory devices and systems, optical memory devices and systems, fixed memory and removable memory. The data processor(s) 120, 180 may be of any type suitable to the local technical environment, and may include one or more of general purpose computers, special purpose computers, microprocessors, digital signal processors (DSPs) and processors based on a multi-core processor architecture, as non-limiting examples.

In accordance with the exemplary embodiments of this invention, and referring to FIG. 2, a phone user (e.g., a user of the MS 100) is enabled to selectively mark one or more individual contacts or groups of contacts in the contact list 130A as a special contact(s) or call back contact(s) (Block 2A). In this context a special contact may be, by example, a family member, a friend, a business customer or client, or anyone for whom the user desires to assume financial responsibility for a call to the user that is originated by the special contact.

When a special contact calls the MS 100, the user accepts the call in a normal manner (Block 2B). This can be accomplished, as non-limiting examples, by pressing an Answer hard or soft key on the MS 100, or by opening the MS 100 cover, or by a voice command, or by any suitable technique by which the user would normally answer an incoming call.

As a result of the caller being identified as special contact in the contact list 130A, and the user accepting the incoming call, the MS 100 instead automatically rejects the call, and stores the number of the calling party (Block 2C). Rejecting the call may be accomplished by sending a message to the network operator that results in termination of the call. If the incoming call is not from a party marked as a special contact in the contacts list 130A, the call is handled in a normal fashion (Block 2Ca).

Subsequently the MS 100 automatically or under control of the user sends back to the network operator 20 the stored number of the automatically rejected call (Block 2D) and thus originates a new call to the originally calling party. The automatic call back can occur immediately, or at some specified later call back time, as discussed below. After the special contact accepts the call back, the call proceeds as a normal voice call, and is thus billed to the account of the user of the MS 100, and not to the originally calling party who is marked as a special contact in the contact list 130A.

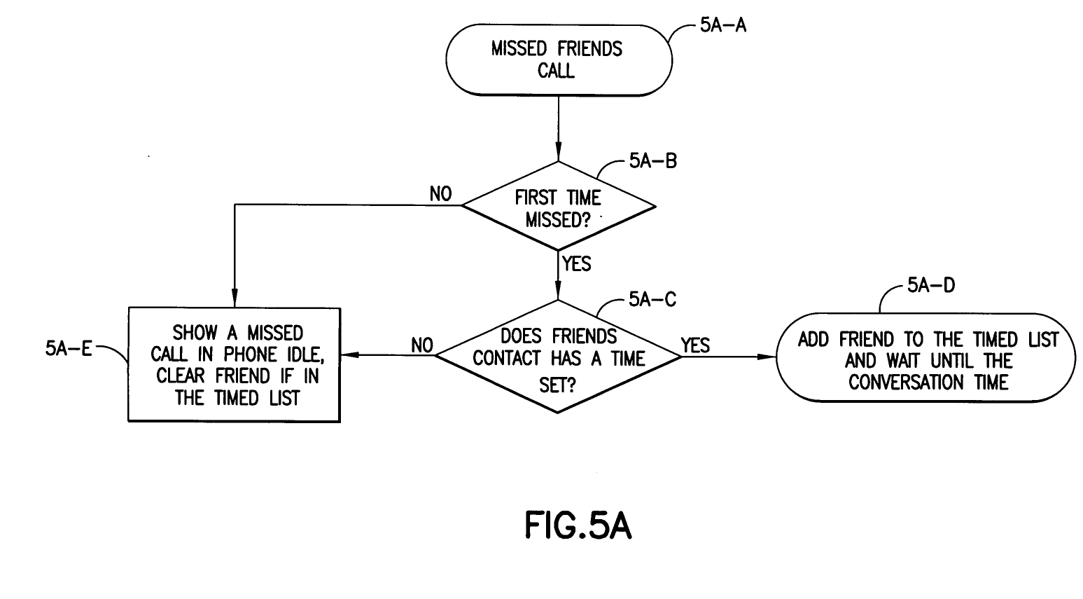

As an optional operation, the user of the called-back phone may send some indication, such as a DTMF signal, during the call to indicate that a message is waiting for the user of the MS 100 (Block 2E). The MS 100 automatically identifies the indication, such as the DTMF signal, and creates a data call to the called-back phone to fetch a short or multimedia message as a data package (Block 2F). Reference in this regard can also be made to FIG. 4, described below.

Note that if the original call to the MS 100 is missed, the MS 100 offers the last missed call for redial, which can be done upon receiving any suitable command from the user, such as pressing a control, or opening the cover of the MS 100. The user of the MS 100 can also set the MS 100 back to idle using any suitable MS 100 control(s).

As was noted above, the call back procedure of Block 2D may be programmed to occur at some predetermined time (e.g., 3 PM), and that this time can be programmed into the enhanced contact list 130A so as to be different for each contact marked as a special contact. During a timed call-back, a personal ringing tone may be played and “accept call” behavior is required to start the call.

When the MS 100 user marks a mobile contact as a special contact, the MS 100 stores this data in a manner similar as other personal information in the contact list 130A, such as the birth date or personal ringing tone. This data may be included in backup and personal computer (PC) type of operations with other personal content synchronization, and may or may not be written into a subscriber identification module (SIM) card, if present in the MS 100.

During execution of Block 2D of FIG. 2 a notification dialog may replace the normal call dialog on the display 140 of the MS 100, and may indicate that the previously accepted call was from a special contact and that the current call will be paid for by the user of the MS 100. The special contact telephone number may be identified from the last few (e.g., six) significant digits, and it may contain an international phone operator as a prefix which will be in use when the call back takes place.

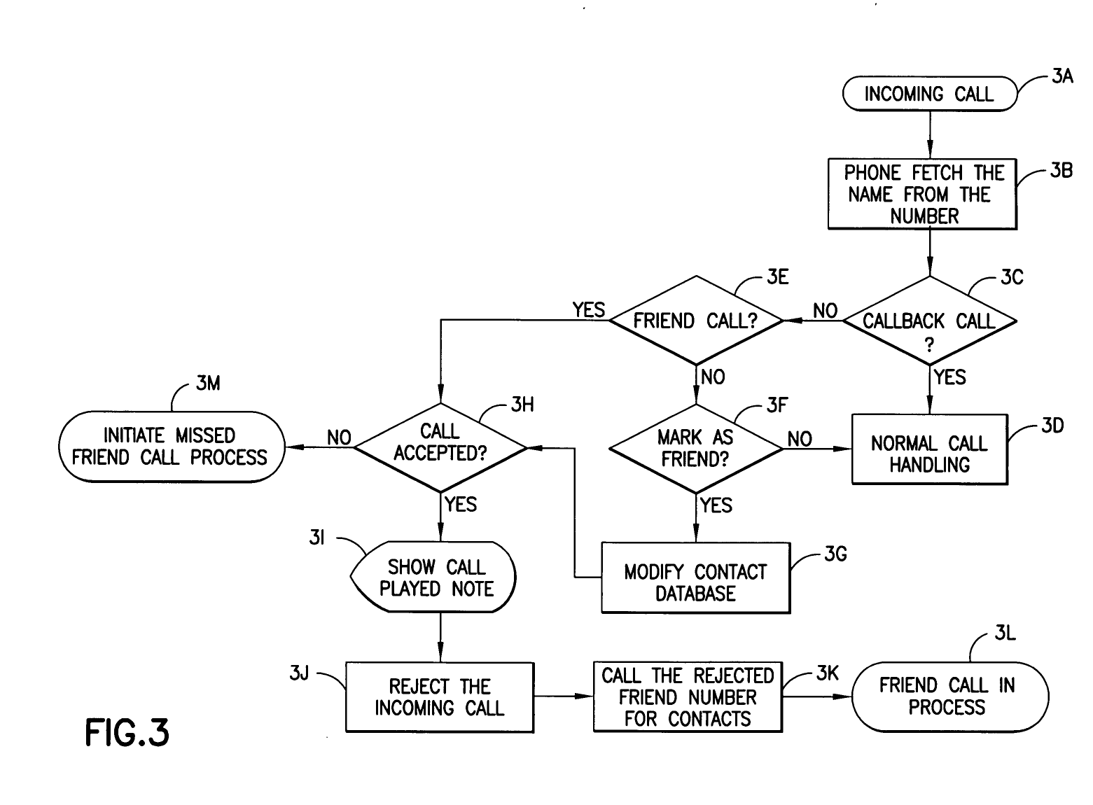

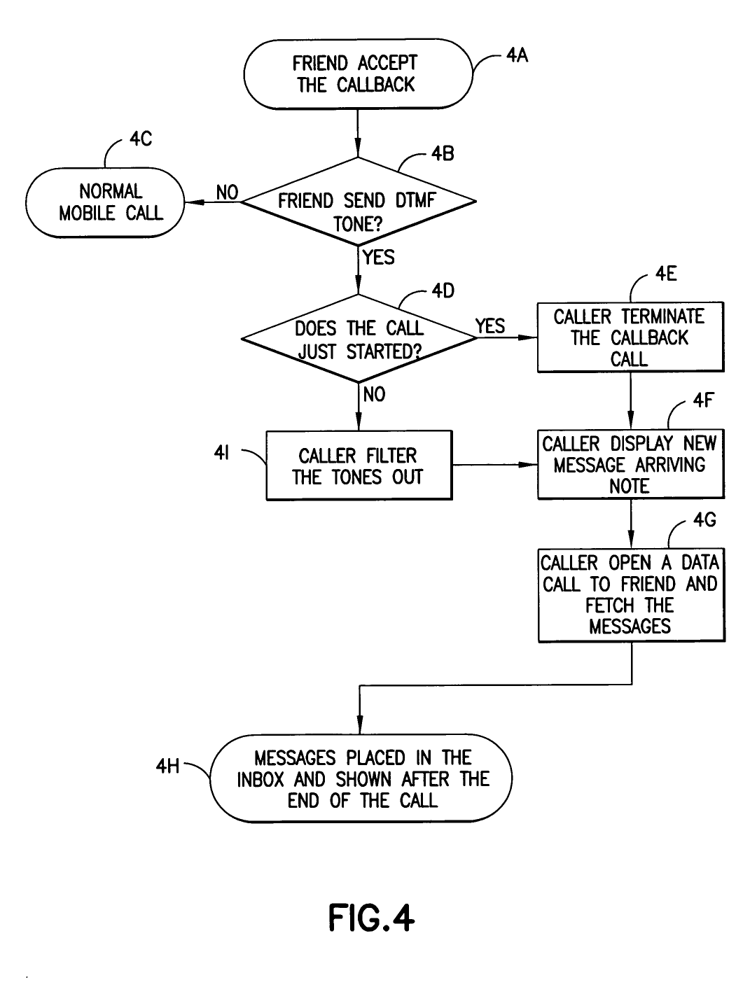

An exemplary embodiment of the overall process is shown in further detail in FIG. 3.

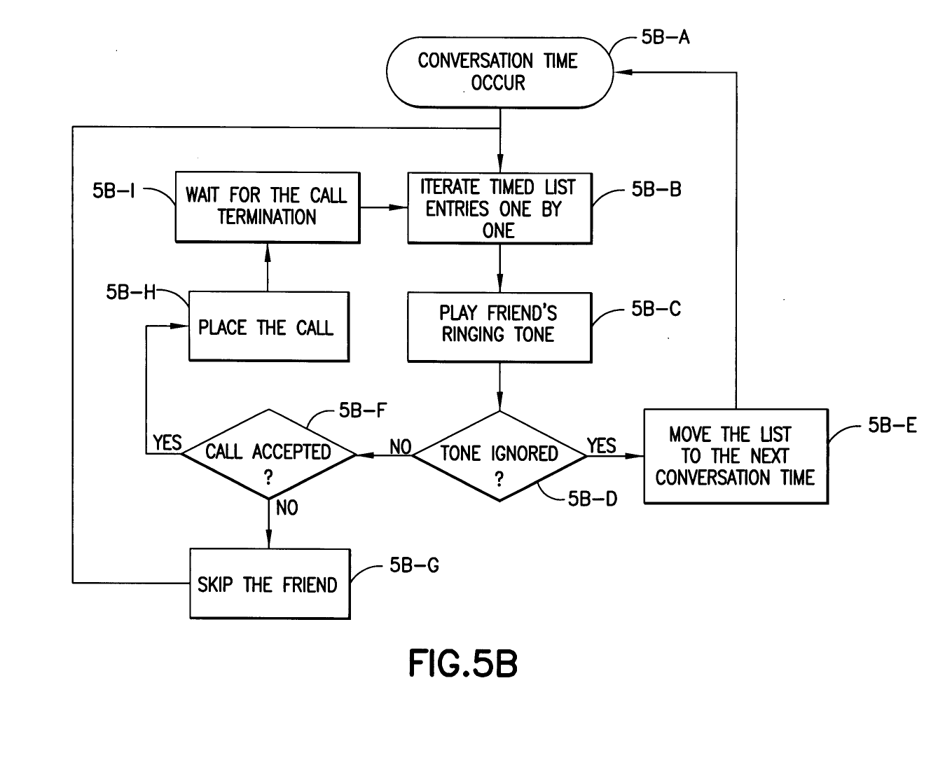

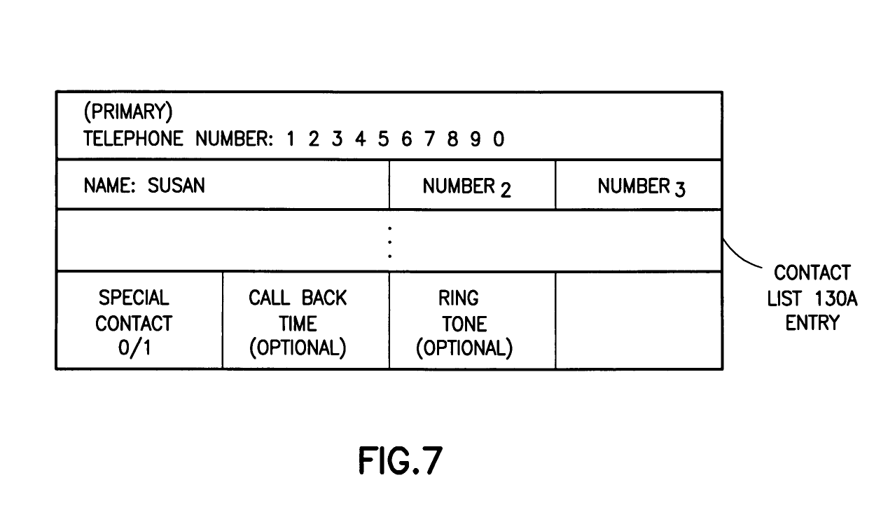

At Block 3A the incoming call arrives. At Block 3B the contact list 130A is accessed to fetch the name associated with the incoming caller's number (calling line identity (CLD) is assumed to in operation, and that the telephone number of the calling party is included in the call signaling sent top the MS 100 from the network operator 20. At Block 3C the MS 100 determines if the incoming call is a call back call (see the discussion of the “ping pong” effect below). If it is, or if CLI is not present for some reason, at Block 3D normal call handling is executed, while if the determination is negative control passes to Block 3E to determine if the call is from a special contact in the contact list 130A. If not, the user is given the opportunity, via the user input 140, to mark the calling party as a special contact (Block 3F), and the contact list 130A is modified accordingly, else normal call handling is performed at Block 3D. If the call is identified as a call from a special contact at Block 3E, or if the call is designated as such at Blocks 3F and 3G, control passes to Block 3H to accept the incoming call (if the call is not accepted then control passes to Block 3M to initiate a missed call process (see FIG. 5). Assuming that the call is accepted at Block 3H, a “called paid” indication of some type may be presented to the user of the MS 100 at Block 31, and at Block 3J the MS 100 automatically sends a message to the network 20 to reject the incoming call (e.g., the MS 100 sends an on-hook or a hang-up or a call termination or some other type of appropriate call signaling to inform the network 20 that the call is terminated without actually being recorded by the network 20 as being answered by the MS 100). Note in this regard that while the user took appropriate action to accept the call at Block 3H, the MS 100 does not send a call accepted message to the network 20, instead the MS 100 sends a call reject indication. At Block 3K the MS 100 automatically calls back the special contact, such as by retrieving a suitable telephone number from the contact list 130A (see the description of FIG. 7 below), and at Block 3L the call back call to the special contact proceeds normally. Note that the logic shown in FIG. 3 differs in some respects to the logic shown in FIG. 2, and that both are considered to be exemplary of the various embodiments that this invention may assume.

As was noted above, after the call established the phone of the special contact may send, for example, a DTMF tone sequence (or other suitable in-call signaling) during the call to indicate there is a message waiting for the caller. This process shown in FIG. 4, where at Block 4A it is assumed that the special contact accepts the call back call, and sends a DTMF tone at Block 4B. This can be done simply by depressing a key (e.g., a numeric key or some other key), or by selecting an appropriate UI menu item on the special contact's phone. If the DTMF tone is not sent then the call proceeds as a normal mobile voice call (Block 4C). If the DTMF tone is sent it is detected by the MS 100 and a determination is made at Block 4D if the call is just starting. If it has, control passes Block 4E to automatically terminate the call back call at the MS 100, and a message is displayed to the user of the MS 100 that a message will be arriving (Block 4F). At Block 4G the MS 100 automatically makes a data call to the special contact to fetch the one or more messages that are waiting (e.g., text and/or multi-media messages). At Block 4H the retrieved message(s) are placed in the inbox of the user of the MS 100 and displayed at the end of the data call (or whenever desired by the user). If the DTMF signal arrives sometime after the start of the call back call (Block 4D), then the MS 100 may filter out the DTMF tone so that it is not audible, and transitions to Block 4F.

Note that at Block 4D, if the DTMF tone is sent at the beginning of the call, the user of the MS 100 has displayed to him or her a new message arriving note and the call is terminated (Block 4E) 1. The new message display can remain active until the message(s) is retrieved. When the special contact party sends a new message notification in this way the MS 100 creates the data call to fetch a text and/or multi-media message. These are messages already created in a draft folder, or being composed in, the phone of the called back special contact, and contain the name of the user of the MS 100 in the “To” field.

It may be the case that the user of the MS 100 has unlimited monthly data calling, e.g., GPRS, 3G access due to using a map or browsing service. The cost of the message pulling may therefore be less than a multi-media message (MMS) sending cost. As it is a data call, this mode of operation may also enabled between operators which have no MMS or SMS inter-operation contract in place, or experience other message-related incompatibilities.

If the call from the special contact is missed (see Block 3M), the MS 100 may offer the last missed call for redial in any manner that is compatible with the construction and operation of the MS 100 user interface. The user of the MS 100 may restore the phone to idle with any suitable controls from a missed call screen.

The contact list 130A may include a conversation time to indicate, as a non-limiting example, a time when the network usage is low and, therefore, the cost of calling may be less. The special contacts may have a related conversational time when an incoming call and a missed call are not displayed as a missed call unless the special contact calls again before the conversational time. The second call indicates an important reason to be called back as soon as possible.

FIG. 5A shows the processing done by the MS 100 when a call from a special contact is missed (Block 5A-A). If this is the first miss (determined by checking the call log 130C of the MS 100, Block 5A-B), a determination is made at Block 5A-C if the corresponding special contact in the contacts list 130A has a call back time set. If the determination is affirmative, the special contact is added to a list (timed list) and is called back at some later time (Block 5A-D), as shown in FIG. 5B. If not, or if this is not the first missed call from the special contact without a call back occurring, control passes to Block 5A-E to show a missed call on the display 140, and to clear the special contact if in the timed list to call back that was established at Block 5A-D.

In FIG. 5B, and when the conversation time is reached (Block 5B-A), at Block 5B-B any entries in the timed list are iterated and for each entry the call back call is originated and the ringing tone of the called back party is played (if available) to the called back party (Block 5B-C). If the tone is ignored (Block 5B-D) the special contact is moved to the next conversation time (Block 5B-E). If instead the call back call is accepted (Block 5B-F, the call is placed (Block 5B-H and at call termination (Block 5B-D) control returns to Block 5B-B to call back the next entry on the timed list (if there is one). If the call is not accepted by the called back party at Block 5B-F then the called back party is skipped and control return to Block 5B-B to call back the next entry on the timed list (if there is one).

Non-priority call backs to special contacts with one missed call may be called back in any suitable order, such as alphabetically. During timed call-back, the special contact-associated personal ringing tone may be played (if present) and “accept call” behavior is required to start the call (Block 5B-F). If no response is received during the timed call, a missed call is created for the special contact. The call creation procedure may include a displayed note that shows that the call is an outgoing call paid for by the user of the MS 100 and requires the called back parties decision to take place. When the called back party is not able to respond to the ringing tone, the missed call's call back can be postponed until the next suitable time (Block 5B-E).

It is noted that it is possible for a callback “ping pong” situation to arise if, for example, two users were to mark all of their contacts as special contacts, or at least one another as special contacts. In such a case, when two financially strong parties call each other, the call cost is not an issue, as both of the parties have indicated a “willing to pay” for the call, and the MS 100 may assume that the party who initiated the call will pay for the cost of the call.

Further in this regard it may be assumed that call setup-related activity takes place within a limited time from the call initiation, and that the phone number of both parties are known and recorded by their respective terminals.

One exemplary approach to avoiding the “ping-pong” call initiation includes the usage of the call log 130C. For example, in Block 3C the terminal can identify that the incoming call is a callback, before identifying that the call is from a special contact. In such a case the incoming call's number is matched with the last dialed call, and if the last call's duration is 00:00:00. When no significant time has passed since a number is dialed and incoming call received it may be assumed that a call back is in progress. In this way the terminal can assume that the current incoming call is a callback response and automatically accept the call and perform normal call handling (Block 3D), as opposed to checking the contact list 130A and rejecting the call. In this case the mobile user pays for the call, even when the calling party also marked the mobile user as a special contact.

Depending on the mobile culture using the exemplary embodiments of this invention, and the specific implementation, the call initiator may pay for the call when both parties marked as special contacts. FIG. 6 shows an example the call log 130C and the steps that are included under the “Callback Call?” block 3C of FIG. 3. The usage of the call log 130C may lead to an identification that the call is a callback where the mobile user pays. However when an incoming call is a callback from a special contact, and there is no callback initiated, the call can be rejected and called back as described in Blocks 3J and 3K. Afterwards the MS 100 detects from the call log 130C that a callback was initiated and rejected previously by user of the MS 100 and, therefore, the MS 100 can accept the callback from the special contact.

Note that in some embodiments the acceptance of the incoming call may be done automatically, based on the number identification in the call log 130C as described above.

Note that additional signaling may be applied to the incoming call from the network 20 to indicate the presence of a call back call, however this solution may require additional complexity, and changes to be made at the level of the network 20, such as to call stacks.

Further by example, in the non-limiting case of a Session Initiation Protocol (SIP) initiated video callback, the SIP INVITE message may use the “the content type” field with an “application/callback”. Optionally other SIP messages may have modification as well to signal the presence of a callback, such as by using a special 2xx response, that the SIP invite is accepted, but that the requested call session is preferred as a call back. In this case, when call back-extended signaling is available a “callback call” filter of the MS 100 may use the information in the signaling stack instead of the call log 130C to identify the nature of the incoming call.

Thus, it can be appreciated that the “ping-pong” situation can be addressed solely by the operation of the MS 100 and/or by the presence of signaling to the MS 100.

Based on the foregoing discussion, and referring to FIG. 7, it can be appreciated that an aspect if the exemplary embodiments of this invention is a data structure that is stored in a tangible memory medium (e.g., MMC, Simcard, internal flash) of, or that is accessible by, the MS 100. The data structure, also referred to herein as the contact list 130A, includes at least one entry having a plurality of fields for storing data. One field stores at least one suitable telephone number, another field stores an identification of a person or organization (party) associated with the at least one suitable telephone number (e.g., the name) and another field stores at least one data bit for indicating to the CL application 130B of the MS 100 whether the associated entry is a special contact, e.g., if the bit is set the entry is a special contact, and if the bit is reset the entry is a normal, non-special contact. The contact list 130A may comprise other related information, for example a field for storing a preferred time for call backs to occur, and field for storing an indication of ring tone to be used at least when making a call back.

It should be noted that there may be more than one suitable number identified with a special contact, for example, the main or primary number that is used to detect the identity of the caller from the incoming call. The other numbers are optional. As non-limiting examples, the second number shown in FIG. 7 (number₂) is a number which can be used to initiate the callback. In an international call, for example, this second number could be for operator, which provides a cost effective international communication solution as compared to the default national carrier in use. It could also be the case that the callback is initiated as a video call, as compared to the original incoming voice call. A third number (number₃) shown in FIG. 7 may be the number used for a data call in a case where callback message sending is in use (to pull a message). Although referred to as “numbers”, such as telephone numbers, in some embodiments they may not be “numbers” per se, but instead may be any suitable caller identifiers, such as those used in VoIP-based services. In a case of non-cellular caller identifiers as call back numbers, the contacts detailed in FIG. 7 may contain a preferred non-cellular network carrier mobile access point, such as a number used in the mobile terminal to identify and create the WiFi connection. In general, the “numbers” stored in the data structure may be of any form and format suitable for enabling contact to be made to the calling party, or some service (e.g., a messaging service) associated with the calling party.

One non-limiting advantage that results from the use of the exemplary embodiments of this invention is that there is no need to provide additional hardware to create a call back service for users. Further, a call back “friend” may have a traditional mobile phone (or fixed line number), and complexity for the called user is reduced, as most or all of the call back procedure can be handled automatically by the MS 100. Still further, the user of the MS 100 may add/remove special contacts in the contact list 130A as desired need without modifying any operator contract and/or without requiring the use of an additional phone number. In addition, sending a message can be accomplished without cost for the special contact, which can improve the frequency of communication between friends and family members.

As should be realized, the exemplary embodiments of this invention are not restricted for use with only mobile devices and terminals, and furthermore can also be used with VoIP, video and other forms of calls.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting embodiments a full and informative description of the invention. However, various modifications and adaptations may become apparent to those skilled in the relevant arts in view of the foregoing description, when read in conjunction with the accompanying drawings and the appended claims.

For example, certain of the steps depicted in the logic flow diagrams may be executed in different orders, and other steps may be added while some may be deleted and/or viewed as optional.

However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
in response to receiving an incoming call at a telephone, indicating acceptance of the call;
determining with the telephone if the incoming call is from a party designated as a special contact;
if it is, automatically rejecting the incoming call; and
automatically initiating a call back to the party.

2. The method of claim 1, where indicating acceptance of the call is performed manually by a user of the telephone.

3. The method of claim 1, where automatically rejecting the call is performed such that the call is not connected, and before the party is billed for making the call.

4. The method of claim 1, where determining comprises examining a contact list entry associated with the party to determine whether the party is designated as the special contact.

5. The method of claim 1, where determining comprises an initial step of making a determination if the incoming call is a call back call from the party, and if it is, accepting the incoming call.

6. The method of claim 1, where if it is determined that the incoming call is not from a party designated as a special contact, giving the user an opportunity to designate the calling party as a special contact and, in response to the user so designating the calling party as a special contact, and in response to accepting the call, automatically rejecting the incoming call and automatically initiating a call back to the calling party.

7. The method of claim 1, further comprising:
in response to the party accepting the call back call;
receiving a message available indication from the party;
automatically terminating the call back call; and
initiating another call back call to the party to retrieve the message.

8. The method of claim 7, where the message available indication comprises a DTMF tone or other in-call signaling.

9. The method of claim 1, where automatically initiating a call back to the party is performed immediately.

10. The method of claim 1, where automatically initiating a call back to the party is performed at a predetermined time in the future.

11. The method of claim 5, where making a determination if the incoming call is a call back call from the party comprises consulting a call log to determine if a call was made to the party.

12. The method of claim 1, where the telephone is a wireless mobile telephone.

13. A computer program product embodied in at least one computer readable storage media and comprising program instructions execution of which by at least one data processor results in operating a telephone, the operations comprising:
in response to receiving an incoming call, and in response to an indication of acceptance of the call;
determining if the incoming call is from a party designated as a special contact;
if it is, automatically rejecting the incoming call; and
automatically initiating a call back to the party.

14. The computer program product of claim 13, where the indication of the acceptance of the call is made by a manual operation of a user of a telephone.

15. The computer program product of claim 13, where automatically rejecting the call is performed such that the call is not connected, and before the party is billed for making the call.

16. The computer program product of claim 13, where determining comprises examining a memory device that stores a contact list entry associated with the party to determine whether the party is designated as the special contact.

17. The computer program product of claim 13, where determining comprises an initial operation of making a determination if the incoming call is a call back call from the party, and if it is, accepting the incoming call.

18. The computer program product of claim 13, where if it is determined that the incoming call is not from a party designated as a special contact, giving a user an opportunity to designate the calling party as a special contact and, in response to the user so designating the calling party as a special contact, and in response to accepting the call, automatically rejecting the incoming call and automatically initiating a call back to the calling party.

19. The computer program product of claim 13, further comprising operations of:
in response to the party accepting the call back call;
detecting receipt of a message available indication from the party;
automatically terminating the call back call; and
initiating another call back call to the party to retrieve the message.

20. The computer program product of claim 19, where the message available indication comprises a DTMF tone or other in-call signaling.

21. The computer program product of claim 13, where automatically initiating a call back to the party is performed immediately.

22. The computer program product of claim 13, where automatically initiating a call back to the party is performed at a predetermined time in the future.

23. The computer program product of claim 17, where making a determination if the incoming call is a call back call from the party comprises consulting a call log stored in a memory device to determine if a call was previously made to the party.

24. The computer program product of claim 13, where the telephone is a wireless mobile telephone.

25. A device, comprising:
an interface to a communications network;
at least one data processor;
at least one memory coupled to the at least one data processor, the at least one memory storing a contact list; and
a user interface coupled to the at least one data processor; where
the data processor is responsive to receiving an incoming call via the network interface, and to an indication of acceptance of the call, to determine if the incoming call is from a party designated as a special contact in the contact list and, if it is, to automatically reject the incoming call and to automatically initiate a call back to the party.

26. The device of claim 25, where the indication of acceptance of the call is received from the user interface.

27. The device of claim 25, where automatically rejecting the call is performed such that the call is not connected, and before the party is billed for making the call.

28. The device of claim 25, where determining comprises initially making a determination if the incoming call is a call back call from the party, and if it is, accepting the incoming call.

29. The device of claim 25, where if the data processor determines that the incoming call is not from a party designated as a special contact, giving a user an opportunity to designate the calling party as a special contact via the user interface and, in response to the user so designating the calling party as a special contact, and in response to accepting the call, automatically rejecting the incoming call and automatically initiating a call back to the calling party.

30. The device of claim 25, the data processor further operable, in response to the party accepting the call back call to detect a message available indication from the party; to automatically terminate the call back call and initiate another call back call to the party to retrieve the message.

31. The device of claim 30, where the message available indication comprises a DTMF tone or other in-call signaling.

32. The device of claim 25, where automatically initiating a call back to the party is performed immediately.

33. The device of claim 25, where automatically initiating a call back to the party is performed at a predetermined time in the future.

34. The device of claim 29, where making a determination if the incoming call is a call back call from the party comprises consulting a call log stored in the at least one memory to determine if a call was previously made to the party.

35. The device of claim 25, where the telephone is a wireless mobile telephone.

36. The device of claim 25, where the telephone has VoIP capabilities.

37. A data structure stored in a memory that is accessible by a wireless terminal, comprising a contact list having at least one entry, the at least one entry comprising a field for storing data indicative of at least one telephone number, a field for storing data indicative of an identification of a party associated with the at least one telephone number, and a field for storing data indicative of whether the party is a special contact who, if a call is received from the special contact, the call is terminated automatically and a call back is performed automatically to the at least one telephone number.

38. The data structure of claim 37, said entry further comprising a field for indication a time at which the automatic call back is to be performed.

39. The data structure of claim 37, said entry further comprising a field for indication a ringing tone to be used when the automatic call back is performed.

40. The data structure of claim 37, said entry further comprising a field for a caller number to where automatic call back is performed.

41. The data structure of claim 37, said entry further comprising a field for a caller number to where automatic back call for a message pull is performed.

42. Apparatus, comprising:
means for receiving an incoming call;
means, responsive to an indication of call acceptance, for determining if the incoming call is from a party designated as a special contact in a stored contact list; and
means, responsive to the determination being affirmative, for automatically rejecting the incoming call and for automatically initiating a call back to the party using call back information stored in the contact list.

43. The apparatus of claim 42, where said means for automatically rejecting rejects the call such that the call is not connected, and before the party is billed for making the call.

44. The apparatus of claim 42, further comprising means, responsive to the incoming call not being from a party designated as a special contact, for enabling a user to designate the calling party as a special contact and, in response to the user so designating the calling party as a special contact, and in response to accepting the call, said means for automatically rejecting the incoming call and automatically initiating a call back to the calling party operating to reject the incoming call and to initiate the call back.

45. The apparatus of claim 42, further comprising means for detecting a message available indication from the party; and means for automatically terminating the call back call and initiating another call back call to pull the message.

46. The apparatus of claim 42, where said means for automatically initiating a call back to the party operates immediately or at a predetermined time in the future.

47. The apparatus of claim 42, further comprising means for detecting if the incoming call is a call back call from the party by consulting a call log to determine if a call was previously made to the party.

48. The apparatus of claim 42, embodied in a wireless communications device.

49. The apparatus of claim 42, embodied in a computer having wireless communications capability.

50. The apparatus of claim 42, embodied in a device having VoIP capability.
